(19) United States
(12) Patent Application Publication
(10) Pub. No.: US 2008/0164846 A1
(43) Pub. Date: Jul. 10, 2008

(54) Apparatus and method to update and maintain a tire pressure monitoring tool

(75) Inventors: Michael T. DeKeuster, Franksville, WI (US); Robert E. Davis, Palatine, IL (US)

Correspondence Address: MCDERMOTT WILL & EMERY LLP, 600 13TH STREET, N.W., WASHINGTON, DC, 20005-3096, US

(73) Assignee: Snap-on Incorporated

(21) Appl. No.: 11/650,473

(22) Filed: Jan. 8, 2007

(51) Int. Cl. H02J 7/00; G01L 17/00

(52) U.S. Cl. 320/115; 73/146.3

(57) ABSTRACT

A dock has a cradle and at least one port for recharging and communicating with a tire pressure monitoring tool. The dock recognizes that the tool is inserted into the dock; evaluates the programming in the memory; compares the programming in the memory against programming stored in a computer; determines whether the programming in the memory is older than the programming stored in the computer; and if the programming in the memory is older than the programming in the computer, then loads the programming from the computer into the memory.

### TECHNICAL FIELD

The present subject matter relates to methods and equipment for updating and maintaining a tire pressure monitoring tool utilizing a dock, and a computer.

### BACKGROUND

In recent years, new federal laws require that most vehicles be outfitted with Tire Pressure Monitoring Systems (TPMS) by Sep. 1, 2007. There are two basic types of TPMS: indirect, and direct.

Indirect TPMS use a vehicle's existing Anti-lock Braking System (ABS) to monitor and compare the rotational speed of each road wheel. The indirect TPMS infers over-inflation if the rotational speed appears too low (due to a large diameter of an over-inflated wheel), and infers under-inflation if the rotational speed appears too high (due to a small diameter of an under-inflated wheel). Indirect TPMS are relatively inexpensive because they utilize pre-existing ABS sensors to infer over-inflation or under-inflation.

Unfortunately, the indirect TPMS is unable to detect tire deflation of typically less than 30%. Also, tire changes require resetting the system to releam the dynamic relationship between wheels, creating lifetime maintenance and calibration issues. And, because the system makes differential measurements, it can not independently treat each wheel. Indirect TPMS cannot detect a case in which all four tires are under-inflated to a similar degree, which can easily occur with similar tires over an extended period of neglect. For these reasons, indirect TPMS systems have fallen out of favor.

Direct Tire Pressure Monitoring Systems (TPMS) are relatively expensive because they require additional hardware and software in the vehicle. However, direct TPMS systems are more accurate because they directly and individually measure the pressure of every tire. For example, direct TPMS systems are capable of generating a driver warning when any or all of the tires fall 20% below the manufacturer's recommended cold-inflation pressures. Additionally, direct TPMS may simultaneously directly measure tire temperatures, and thus may compensate for cold-to-warm-running tire-pressure changes and for temperature dependencies within the pressure sensors. For these reasons, direct TPMS appear to be the only systems that will satisfy the strict requirements of new federal regulations.

Typically, a tire sensor is built into a valve stem of a tire, and may transmit information such as a sensor identification (ID), pressure, and temperature to a vehicle control module. The tire sensor (or tire pressure monitoring sensor) typically comprises a battery, a communication antenna, a pressure sensor, and a memory for storing a sensor identification.

The tire sensor battery is physically small, and accordingly has a corresponding small energy storage capacity. To maximize the life of the battery, the tire sensor conserves energy by “sleeping” (not measuring pressure or temperature, and not transmitting information) until it receives an triggering signal. For example, a vehicle may send one triggering signal after the engine has been started, and send a second triggering signal after the car has been moving for 5 minutes. After receiving an triggering signal, the tire sensor may measure a pressure and a temperature, and then transmit the pressure, the temperature, and a sensor ID to a vehicle control module or TPMS of a vehicle. After transmitting, the tire sensor may return to sleep in order to conserve battery energy. Triggering formats include continuous wave, modulated pulse, and magnetic. Different sensor manufacturers may use different triggering formats.

Using unique sensor IDs allows the TPMS to identify a specific tire, and to ignore tires from other cars. A vehicle may have an instrument cluster display (or a vehicle tire pressure monitoring system display) that displays tire positions. The vehicle must be trained or programmed with the position of each specific tire. For example, tire ID 123 may be located at the front left tire location. A tire pressure monitoring tool is used to trigger the tire sensor to transmit the tire ID 123, and thus train the vehicle that the tire with ID 123 is located at the front left position.

Typically, during training the front left tire sensor is triggered first, then the right front tire sensor, next the right rear tire sensor, and finally the left rear tire sensor. Some vehicles also train the spare tire between the right rear and the left rear. Each time that a tire is changed, or a tire position is changed (such as tire rotation), the TPMS must be retrained.

A current conventional tire pressure monitoring tool utilizes six AA size batteries for power to trigger the tire sensor. The conventional tool must be partially disassembled to access and remove the AA batteries for replacement. For example, the Snap-on® Tire Pressure Monitoring System Tool model TPMS1 uses six AA size batteries. Performance of the tool may degrade as the batteries run down.

Additionally, new tire sensors may require new triggering procedures, and the conventional tool should be regularly updated with new software containing the new triggering procedures.

Unfortunately, the conventional tool requires a complex procedure to update the programming or software. The complex procedure typically requires following steps: (1) the pressure monitoring tool is partially disassembled by removing an access plate and a battery pack to access an internal communication port; (2) the first end of a first communication line is manually inserted to the internal communication port; (3) the second end of the first communication line is inserted into a programming interface module (PIM); (4) the programming interface module is connected with a second communication line to a computer with Internet access; (5) a mechanic uses the computer to log into an Internet website; (6) if necessary, additional licenses are purchased by the mechanic from an appropriate Internet site; (7) appropriate software is downloaded to the pressure monitoring tool; (8) both communication cables and are disconnected; (9) the battery pack is replaced inside the tool; (10) the access plate is replace on the tool; (11) the programming interface module is stored; and (12) both communication cables are stored for future use.

In summary, updating the software on a conventional tool is a complex procedure requiring a separate device (programming interface module) which may easily be lost in a busy shop, two communication lines, and about 12 procedural steps by the mechanic. The mechanic is typically highly trained, and his or her time may be very valuable. Similarly, monitoring the battery charge level and replacing the batteries requires time and effort on a regular basis from the mechanic.

Thus, the tendency in a busy shop may be for the batteries to become run down and for the software to become out of date. For these reasons, conventional tire pressure monitoring tools may operate poorly due to weak batteries, and may operate incorrectly due to outdated software.

Desired are systems that keep the batteries charged and keep the triggering procedures updated without requiring complex procedures from a busy mechanic.

### SUMMARY

The teachings herein improve over conventional tire pressure monitoring tools by providing a dock with (1) a cradle for receiving a tire pressure monitoring tool and (2) at least one port for recharging and updating the tire pressure monitoring tool. The tire pressure monitoring tool may have a rechargeable battery and a memory storing programming for the tool.

For example, a dock for a tire pressure monitoring tool may include a cradle for receiving the tool, and at least one port for recharging the rechargeable battery and communicating with the memory of the tool. The dock may recognize whether the tool is in the cradle, and may recognize whether the rechargeable battery is being recharged, and may recognize the level of charge in the rechargeable battery. The dock may update the memory of the tool under certain circumstances.

Additionally, the tire pressure monitoring tool may include a rechargeable battery, a memory, and at least one port for recharging the battery and updating the memory. The tire pressure monitoring tool may be adapted to snugly mate into a cradle of a dock, and thus be physically stable while recharging the battery and updating programming in the memory.

In accord with another aspect, a method for maintaining a tire pressure monitoring tool having a rechargeable battery and a memory storing programming includes: recognizing that the tool is inserted into a dock; evaluating the programming in the memory; comparing the programming in the memory against programming stored in a computer; determining whether the programming in the memory is older than the programming stored in the computer; and if the programming in the memory is older than the programming in the computer, then loading the programming from the computer into the memory.

The computer may be local computer, or the computer may be a distant computer accessed through a communications network such as the Internet. If the programming in the memory of the tool is older than the programming stored in the computer, then the programming in the computer is loaded into the memory of the tool. Thus, the programming in the memory of the tool is updated to enable the tool to trigger new sensors.

Further, various methods are disclosed for initiating the evaluation of the programming in the tool. One method evaluates the programming every time that the tool is inserted in the dock.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of the methodologies, instrumentalities and combinations particularly pointed out in the appended claims.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a functional block diagram of a conventional tire sensor for a direct measurement Tire Pressure Monitoring System (TPMS).

FIG. 2 is a functional block diagram of a tire pressure monitoring tool, for triggering a tire sensor for a direct measurement Tire Pressure Monitoring System (TPMS).

FIG. 3 is a functional block diagram of a Tire Pressure Monitoring Systems (TPMS) of a vehicle, including a typical instrument cluster display (or a vehicle tire pressure monitoring system display) that graphically displays tire positions.

FIG. 4 illustrates a typical training procedure, in which a tire pressure monitoring tool triggers a tire pressure monitoring sensor, and the tire pressure monitoring sensor reports to a Tire Pressure Monitoring Systems (TPMS) of a vehicle.

FIG. 5 illustrates a typical arrangement for updating the programming of a tire pressure monitoring tool.

FIG. 6 illustrates an exemplary dock for a tool pressure monitoring tool, and the tire pressure monitoring tool adapted to mate with the dock.

FIG. 7 is a flowchart illustrating an exemplary method for maintaining a tire pressure monitoring tool having a rechargeable battery and a memory storing programming.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

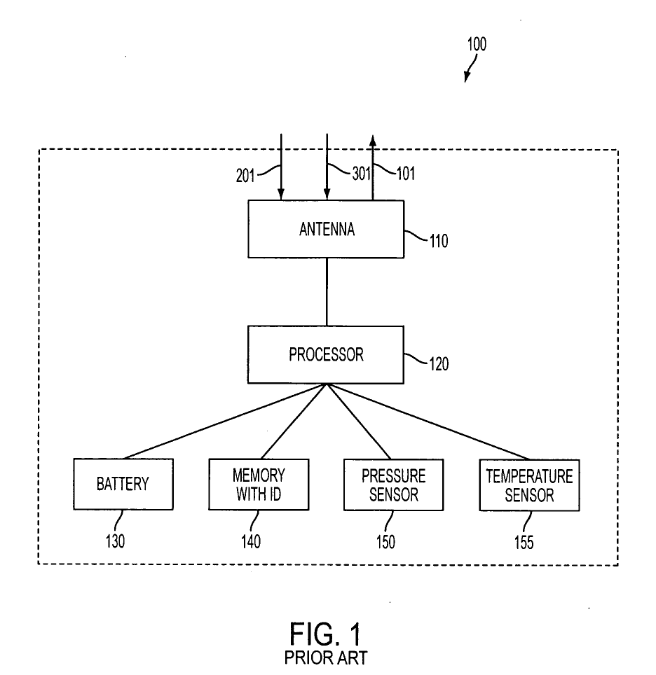

FIG. 1 is a functional block diagram of a conventional tire sensor for a direct measurement Tire Pressure Monitoring System (TPMS). Tire sensor 100 comprises an antenna 110, a processor 120, a battery 130, a memory 140 storing at least a sensor identification, a pressure sensor 150, and a temperature sensor 155 interconnected as shown. Typically the tire sensor 100 is located at the base of the air stem in a tire. The tire sensor may also have circuitry (not shown) for monitoring the status of the battery 130.

The tire sensor 100 generally remains in sleep mode (not measuring pressure or temperature, and not transmitting) until the tire sensor 100 receives a proper triggering signal through the antenna 110. Triggering signal 201 is generated by a tire pressure monitoring tool 200 (not shown), and triggering signal 301 is generated by the Tire Pressure Monitoring Systems (TPMS) of a vehicle 300 (not shown).

In response to triggering signal 201 or 301, the tire sensor 100 typically wakes up to perform the following functions: recall a sensor identification from memory 140, measure a pressure using pressure sensor 150, measure a temperature using temperature sensor 160, and measure the status of battery 130. After recalling and measuring, the tire sensor 100 transmits a reporting signal 101 which carries the sensor identification and the measured data. The same antenna 110 may be used for receiving triggering signals, and also for transmitting reporting signals.

With ordinary use, the triggering signal 301 will regularly be transmitted by a Tire Pressure Monitoring System (TPMS) of a vehicle (not shown). For example, a triggering signal may be transmitted upon start up of the vehicle, and then an additional triggering signal may be transmitted after 5 minutes of driving. Further, during diagnostic testing or when a tire is changed or rotated, then a triggering tool (not shown) may be used to trigger a specific tire in order to learn the location of the specific tire on the vehicle.

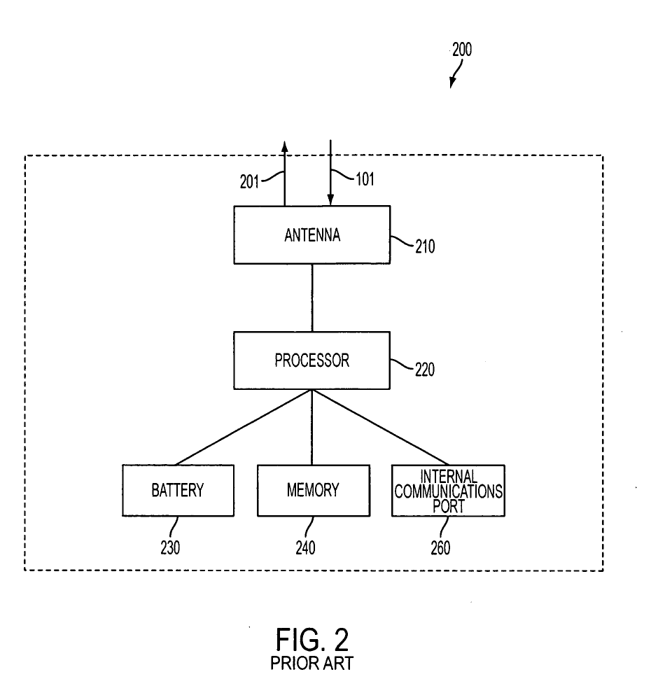

FIG. 2 is a functional block diagram of a tire pressure monitoring tool, for triggering a tire sensor for a direct measurement Tire Pressure Monitoring System (TPMS). Tire pressure monitoring tool 200 comprises an antenna 210, a processor 220, a battery 230, a memory 240, and an internal communications port 260 interconnected as shown. Typically antenna 210 transmits a triggering signal 201 to sensor 100 (FIG. 1). In some tool models, the antenna 210 may receive a reporting signal 101 and the tool 200 may report that the sensor has been triggered. For example, a red LED on the tool 200 (not shown) may light up indicating that that the sensor 100 (FIG. 1) has been triggered.

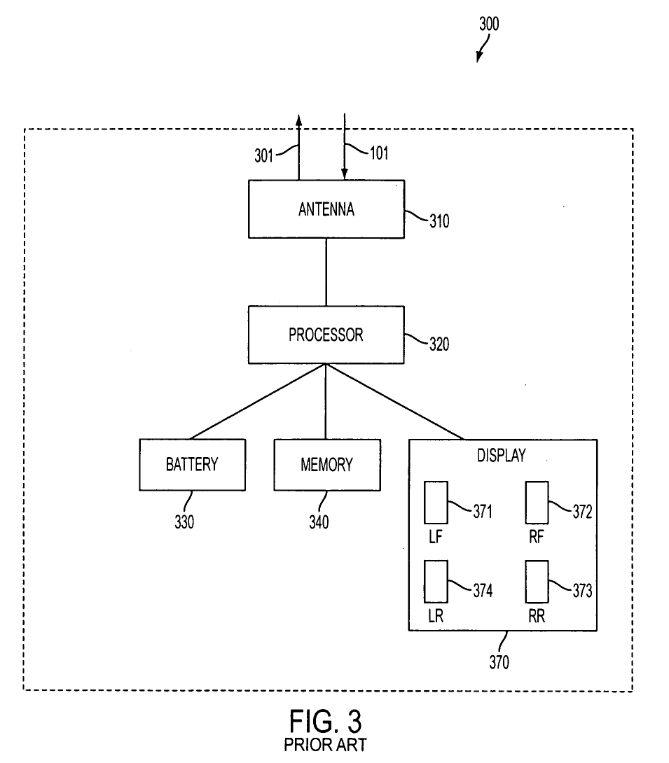

FIG. 3 is a functional block diagram of a Tire Pressure Monitoring System (TPMS) of a vehicle, including a typical instrument cluster display (or a vehicle tire pressure monitoring system display) that graphically displays tire positions. The Tire Pressure Monitoring Systems (TPMS) 300 typically comprises: an antenna 310; a processor 320; a battery 330; a memory 340; and an instrument cluster display 370 with a left front tire icon 371 labeled LF, a right front tire icon 372 labeled RF, a right rear tire icon 373 labeled RR, and a left rear tire icon 374 labeled LR interconnected as shown. The antenna 310 may transmit triggering signal 301, and may receive reporting signal 101. During normal use of a car, a triggering signal may be transmitted upon start up of the vehicle, and then an additional triggering signal may be transmitted after 5 minutes of driving.

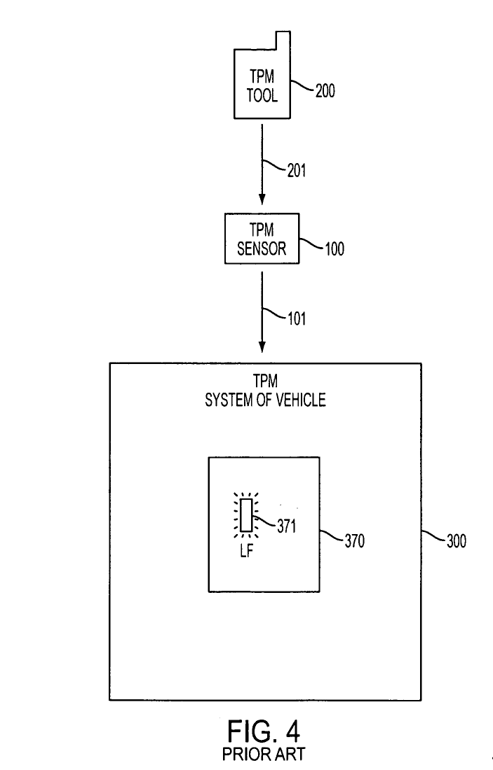

FIG. 4 illustrates a typical training procedure, in which a tire pressure monitoring tool triggers a tire pressure monitoring sensor, and the tire pressure monitoring sensor reports to a Tire Pressure Monitoring Systems (TPMS) of a vehicle. The tire pressure monitoring tool 200 transmits the triggering signal 201 to the tire pressure sensor 100 of a tire in a known position, for example in the left front position. The tire pressure sensor 100 receives the triggering signal 201 and transmits the reporting signal 101 (a sensor identification and measured data including a tire pressure). The Tire Pressure Monitoring System (TPMS) 300 receives the reporting signal 101, and associates the sensor identification of tire pressure sensor 100 with a specific tire position such as the left front position. The procedure for training or teaching tire pressure sensor positions to the Tire Pressure Monitoring System (TPMS) 300 typically presumes that the first reporting signal 101 received is from a sensor 100 located in the left front tire of the vehicle. The TPMS 300 typically has an instrument cluster display 370 with a left front tire icon 371 labeled LF. The left front tire icon 371 labeled LF may light up or change color to indicate that a sensor identification has been associated with the left front position. The remaining tires may be sequentially triggered in a specified order to train the Tire Pressure Monitoring System (TPMS) 300 regarding the sensor identifications and locations of the remaining tires.

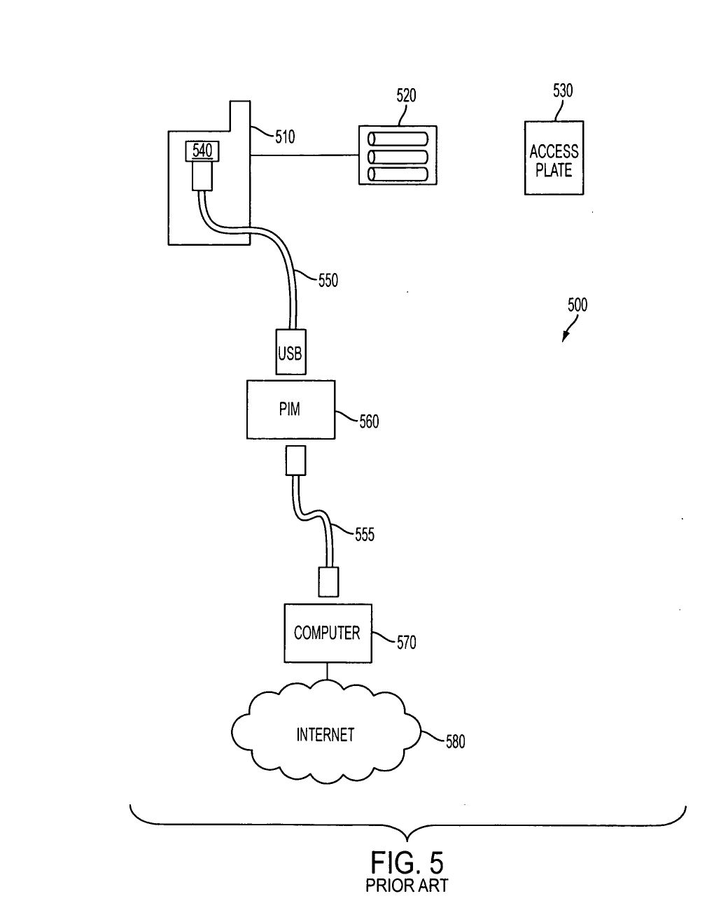

FIG. 5 illustrates a typical arrangement for updating the programming of a tire pressure monitoring tool. A disassembled tire pressure monitoring tool 510 is illustrated. An access plate 530 has been removed to expose the interior of the disassembled tire pressure monitoring tool 510. A battery pack 520 has been removed from the interior to expose an internal communications port 540, but the battery pack 520 remains connected to the interior with power wiring. A first end of a communication line 550 has been inserted into the internal communications port 540, and a second end of the communication line 550 has been inserted into a Programming Interface Module (PIM) 560. Similarly, a second communication line 555 links the Programming Interface Module (PIM) 560 with a computer 570. The computer 570 may be linked to tool service sites or tire manufacturing sites on the Internet 580.

A conventional tool pressure monitoring tool requires a complex procedure to update the programming or software for triggering new tire sensors. The complex procedure typically requires following steps: (1) the tire pressure monitoring tool 510 is partially disassembled by removing the access plate 530 and the battery pack 520 to access the internal communication port 540; (2) the first end of the first communication line 550 is manually inserted to the internal communication port 540; (3) the second end of the first communication line 550 is plugged into the programming interface module (PIM) 560; (4) the programming interface module 560 is connected with the second communication line 555 to the computer 570 with Internet 580 access; (5) a mechanic uses the computer 570 to log into an Internet 580 website; (6) if necessary, additionally licenses are purchased by the mechanic from an appropriate Internet site; (7) appropriate software is downloaded to the pressure monitoring tool 510; (8) both communication cables 550 and 555 are disconnected; (9) the battery pack 520 is replaced inside the tool 510; (10) the access plate 530 is replace on the tool 510; and (11) the programming interface module 560 is stored for future use; and (12) both communication cables 550 and 555 are stored for future use.

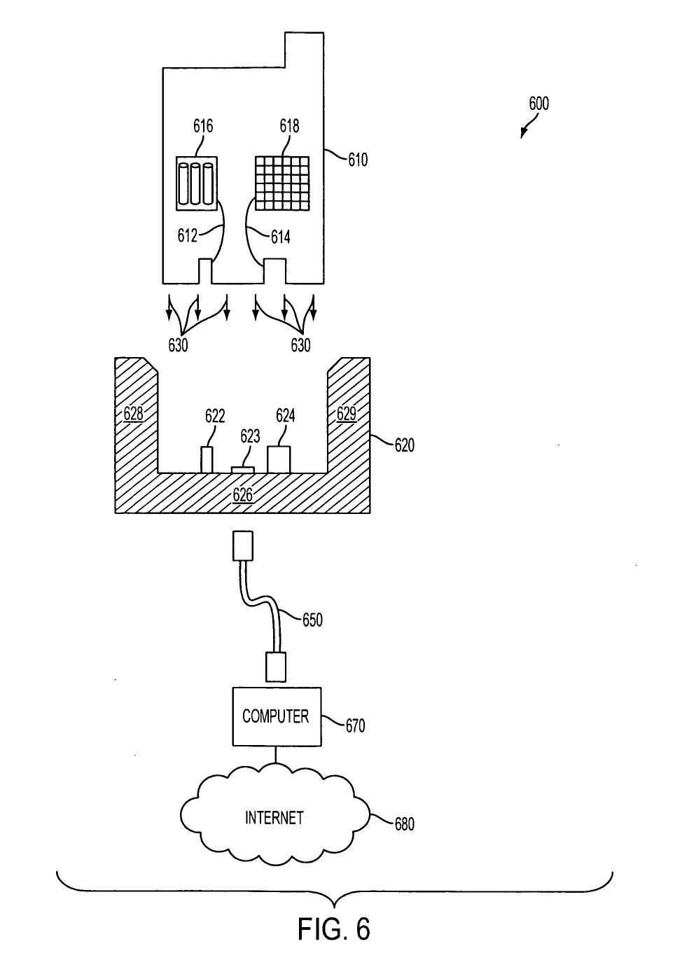

FIG. 6 illustrates a cross sectional view of an exemplary dock for a pressure monitoring tool, and a tire pressure monitoring tool adapted to mate with the dock. The dock 620 includes a cradle 626 adapted to receive a tool 610 in a mating position. The cradle 626 includes left guide 628 and a right guide 629 designed to snugly guide the tool 610 into a mating position. The cradle 626 further includes a male (protruding) recharging port 622, a male communications port 624, and an optional contact sensor 623.

The tire pressure monitoring tool 610 includes a female (recessed) recharging port 612 connected to a rechargeable battery pack 616, and a female communications port 614 connected to a memory 618. When the tool 610 is not in use, a mechanic may insert the tool 610 into the cradle 620 in the direction of arrows 630. The cradle left guide 628 and right guide 629 will properly position the tool 610 as it slides into a mating position. In the mating position, the male recharging port 622 is inserted into the female recharging port 612, the male communications port 624 is inserted into the female communications port 618, and the optional contact sensor 623 is contacted by the tool 610.

The dock 620 is connected to a computer 670 through a communications cable 650, and the computer 670 has access to the Internet 680. Preferably the dock 620 remains connected to the computer 670 so that the dock 620 is always ready to accept the tool 610.

The dock 620 has two main purposes. The first main purpose is to recharge the rechargeable battery 616. The dock 620 may have built-in circuitry adapted to transform a 115 VAC power source (not shown) into an appropriate recharging DC voltage, or may utilize power from the computer 670 to recharge the rechargeable battery 616. The dock 620 may utilize an optional contact sensor 623 (electrical or mechanical) to detect the presence of the tool 610, and may only provide recharging power when the tool 610 is present. The dock 620 or the computer 670 may also evaluate the status of the rechargeable battery 616, and may vary the recharging voltage or current appropriately.

The second main purpose is to update programming or protocols stored in the memory 618 of tool 610. The dock 620 and/or the computer 670 will recognize that the tool 610 is mated into the dock 620. Then the computer 670 will evaluate the programming in the memory 618 against programming stored in the computer 670 or in a manufacturer's computer accessed through the Internet 680, or against programming stored in a service provider's computer accessed through the Internet 680.

A third purpose may be to store the tool 610 in a convenient location until the tool 610 is needed again. For example, the dock 620 may be mounted in a convenient location on a wall or on a shelf, with the tool 610 in the mated position.

In one implementation, the computer 670 automatically checks the Internet 680 once each day for new programming, and may automatically download the new programming into the computer 670 if any is available. This automatic checking may occur periodically, such as once each night, when the computer is not actively used. If the tool 610 is present in the dock 620 when new programming is downloaded into the computer 670, then the computer 670 may load the new programming into the memory 618 of the tool 610 promptly. Otherwise, the computer 670 and the dock 620 will wait until the presence of the tool 610 is detected, and then perform any necessary loading into the memory 618.

In a second implementation, the computer 670 will check the Internet 680 every time that the tool 610 is detected in the dock 620. Contact sensor 623 may be used to detect the presence of the tool 610 in the dock 620. Alternatively, the male communications port 620 may be effectively used to detect the presence of tool 610 by using “plug-and-play” software protocols, such as Universal Plug and Play (UPnP).

The exemplary ports shown in dock 620 and tool 610 are male/female type ports. These ports preferably have sliding contact connections which provide very good contacts because metal oxides (and any dirt) are physically scraped off as the contacts slide into place. These sliding contacts are inexpensive, well known, and add physical stability to the mated position of the dock 620 and the tool 610. Female or recessed ports are preferably used in the tool 610 to avoid physical damage to the ports during use of the tool 610. Male ports in dock 620 are at least partially protected by left guide 628 and right guide 629 of cradle 626 from accidental physical damage. The guides 628 and 629 may wrap all of the way around the tool 610 and form a single protective perimeter (not shown). A single port may be used for recharging and for communications.

The communications cable 650 is shown as a separate unit, but may be merged into the dock 620, or may physically pass through the dock 620 and be physically locked or glued in a proper position in the cradle 626.

Other types of ports may also be used. For example, simple direct (not sliding) contacts may be used. Non-contact communications may also be used. The male communications port 620 may be replaced by a dock antenna (not shown), and the dock antenna may communicate wirelessly with the tool 610.

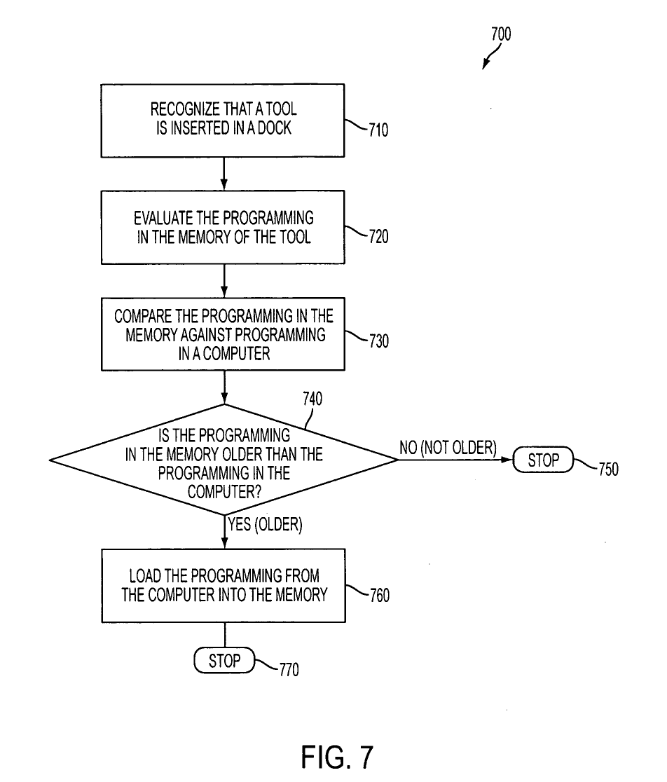

FIG. 7 is a flowchart illustrating an exemplary method for maintaining a tire pressure monitoring tool having a rechargeable battery and a memory storing programming. The exemplary method 700 includes the following steps: recognizing that the tool is inserted into a dock at step 710; evaluating the programming in the memory at step 720; comparing the programming in the memory against programming stored in a computer at step 730; determining whether the programming in the memory is older than the programming stored in the computer at step 740; if the programming in the memory is older than the programming in the computer, then loading the programming from the computer into the memory at step 760 and stopping at step 770; alternatively, if the programming is the memory is not older than the programming in the computer, then stopping at step 750.

Further, the computer 670 may be a local mechanical shop computer, and may search a manufacturer's or a service provider's Internet site 680 for new programming every time that the tool is inserted. Preferably, the local mechanical shop computer may search the Internet site 680 for new programming at a regular periodic interval, such as once each 24 hours, or once each week. In this preferable fashion, the computer 670 remains regularly updated, and evaluates whether to update the tool 610 each time that the tool 610 is inserted into the dock 620.

As discussed above with respect to FIG. 6, the dock 620 or the computer 670 may also monitor the status of the rechargeable battery 616 in the tire pressure monitoring tool 610, and provide appropriate recharging voltage or current to the rechargeable battery 616. The dock 620 or computer 670 may also display the status of the rechargeable battery 616. For example, three light emitting diodes (LEDs, not shown) on the dock may indicate green for fully charged, yellow for partially charged, and red for discharged. Similarly, other light emitting diodes (LEDs, not shown) may indicate whether the tool memory 618 is receiving new programming.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A dock for a tire pressure monitoring tool having a rechargeable battery and a memory storing programming for the tool, the dock comprising:
a cradle for receiving the tool; and
at least one port associated with the cradle and configured for (1) recharging the rechargeable battery and (2) communicating with the memory.

2. The dock of claim 1, wherein the at least one port is configured for recognizing a characteristic of the tool.

3. The dock of claim 2, wherein the at least one port is configured for recognizing whether the tool is in the cradle.

4. The dock of claim 2, wherein the at least one port is configured for recognizing whether the rechargeable battery is recharging.

5. The dock of claim 2, wherein the at least one port is configured for recognizing whether the memory is communicating.

6. The dock of claim 1, wherein the at least one port is configured for updating programming into the memory.

7. The dock of claim 1, wherein the at least one port is integrally positioned inside of or adjacent to the cradle; and the cradle is configured for mechanically guiding the tool into the at least one port.

8. The dock of claim 1, wherein the at least one port comprises a universal serial bus.

9. A tire pressure monitoring tool comprising:
a rechargeable battery;
a memory; and
at least one port associated with the tool and configured for (1) recharging the rechargeable battery and (2) communicating with the memory.

10. A method for maintaining a tire pressure monitoring tool having a rechargeable battery and a memory storing programming, the method comprising:
recognizing that the tool is inserted into a dock;
evaluating the programming in the memory;
comparing the programming in the memory against programming stored in a computer;
determining whether the programming in the memory is older than the programming stored in the computer; and
if the programming in the memory is older than the programming in the computer, then loading the programming from the computer into the memory.

11. The method of claim 10, wherein said evaluating, comparing, determining, and conditional loading are performed exactly once each time that the tool is recognized.

12. The method of claim 10, wherein the computer:
searches for new programming located outside of the computer exactly once each time the tool is recognized; and
downloads the new programming if the search finds any new programming.

13. The method of claim 10, wherein the computer searches for new programming at a regular periodic interval.

14. The method of claim 13, wherein the regular periodic interval is 24 hours.

15. The method of claim 13, wherein the regular periodic interval is one week.

16. The method of claim 13, wherein the regular periodic interval is one month.

17. The method of claim 10, additionally comprising:
determining a status of the rechargeable battery; and
recharging the rechargeable battery if the status is low.
